(19) United States
(12) Patent Application Publication
(10) Pub. No.: US 2025/0122056 A1
(43) Pub. Date: Apr. 17, 2025

(54) EXHAUST PIPE LIFTING APPARATUSES AND METHODS OF USE

(71) Applicant: Toyota Motor Engineering & Manufacturing North America, Inc., Plano, TX (US)

(72) Inventors: Lloyd R. Holland, Georgetown, KY (US); Scottie L. Foster, Lawrenceburg, KY (US); Bradley J. Garcia, Louisville, KY (US); Michael C. Greenlee, Paris, KY (US); Jeffrey L. James, Mount Sterling, KY (US); Jason E. Anderson, Lexington, KY (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/380,952

(22) Filed: Oct. 17, 2023

(51) Int. Cl. B66F 7/28; B66F 7/06; B66F 11/04

(52) U.S. Cl. CPC B66F 7/28; B66F 7/0625; B66F 11/042

(57) ABSTRACT

An exhaust pipe lifting apparatus includes a support frame and a lift table assembly including a lift frame configured to move vertically relative to the support frame. The support frame including a roller rotatably connected thereto that rolls against the lift frame as the lift frame moves between raised and lowered positions and interlocks with a locking feature on the lift frame in the raised position.

### TECHNICAL FIELD

The present specification generally relates to lifting apparatuses and associated methods, and more specifically, lifting apparatuses used in lifting exhaust pipes for assembly onto vehicles.

### BACKGROUND

In order to install exhaust pipes on vehicles during assembly, the vehicles are typically lifted to an elevated position to provide greater access to underneath the vehicle. Lifting the vehicle to the elevated position also provides greater space for locating exhaust pipes under the vehicles. The exhaust pipes must then be lifted and held in place for installation. However, the exhaust pipes are heavy and difficult to lift and install manually. To this end, a lifting apparatus may be used to lift the exhaust pipes for an installation operation. What is needed are other exhaust pipes lifting apparatuses that are useful in lifting and installing exhaust pipes on vehicles.

### SUMMARY

In one embodiment, an exhaust pipe lifting apparatus includes a support frame and a lift table assembly including a lift frame configured to move vertically relative to the support frame. The support frame including a roller rotatably connected thereto that rolls against the lift frame as the lift frame moves between raised and lowered positions and interlocks with a locking feature on the lift frame in the raised position.

In another embodiment, a method of lifting an exhaust pipe using an exhaust pipe lifting apparatus is provided. The method includes placing an exhaust pipe on a lift table of a lift table assembly of the exhaust pipe lifting apparatus. The exhaust pipe lifting apparatus is moved to a desired position. A locking member mounted to a support frame of the exhaust pipe lifting apparatus is released from a locking feature carried by the lift table assembly. A lifting force is applied to the lift table assembly using a retracting device. The lift table assembly is lifted relative to the support frame thereby lifting the exhaust pipe.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a diagrammatic back view of an exhaust pipe lifting apparatus with lift table assembly in a lowered position, according to one or more embodiments shown and described herein;

FIG. 2 is a diagrammatic front view of the exhaust pipe lifting apparatus of FIG. 1 with the lift table assembly in a raised position, according to one or more embodiment shown and described herein;

FIG. 3 is a diagrammatic detail view of portions of the lift table assembly of FIG. 1 showing a locking arrangement between a support frame and the lift table assembly, according to one or more embodiments shown and described herein;

FIG. 4 is a diagrammatic view of the exhaust pipe lifting apparatus of FIG. 1 in use with the lift table assembly in the raised position, according to one or more embodiments shown and described herein;

FIG. 5 is a diagrammatic view of the exhaust pipe lifting apparatus of FIG. 1 in use with the lift table assembly in the raised position, according to one or more embodiments shown and described herein; and

FIG. 6 is a diagrammatic view of the exhaust pipe lifting apparatus of FIG. 1 in use with the lift table assembly in the raised position and with an exhaust pipe slid to one side, according to one or more embodiments shown and described herein.

### DETAILED DESCRIPTION

The present description is generally directed to an exhaust pipe lifting apparatus that can be used to lift and install an exhaust pipe onto a vehicle. The exhaust pipe lifting apparatus includes a support frame and a lift table assembly. The lift table assembly includes a lift frame that is configured to move vertically relative to the support frame. The support frame includes a roller that is rotatably connected thereto. The roller is arranged and configured to roll against the lift frame as the lift frame moves between raised and lowered positions and interlocks with a locking feature on the lift frame in one or both of the raised and lowered positions. A sliding handle can be used to move the roller between engaged and disengaged positions.

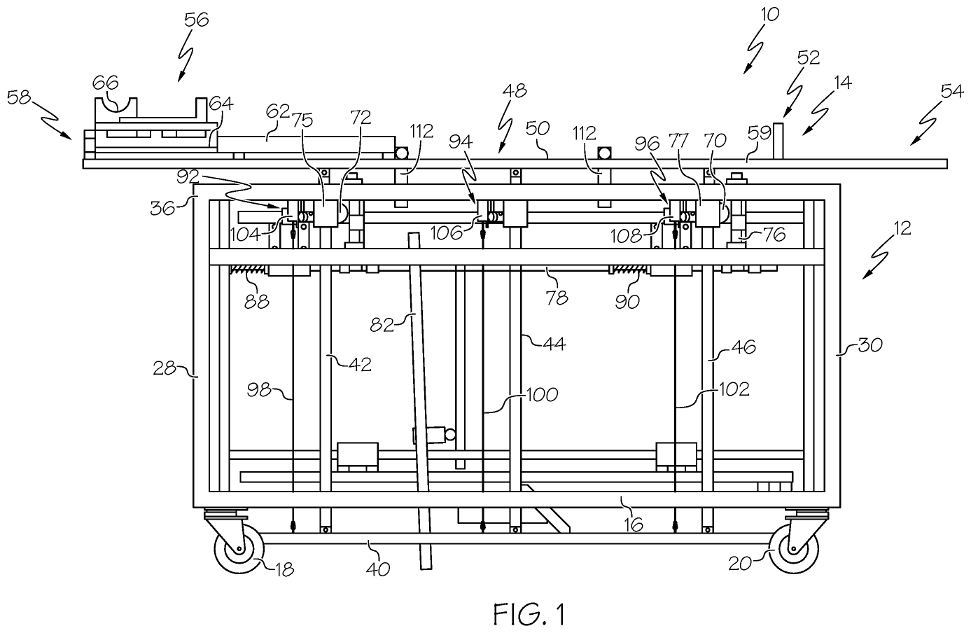

Referring to FIG. 1, an exhaust pipe lifting apparatus 10 includes a support frame 12 and a lift table assembly 14. The support frame 12 includes a base 16 that extends horizontally between rollers 18, 20, 22 and 24 (e.g., wheels) that can roll along a floor toward and away from a vehicle. A brake member 26 may be provided that can be actuated in order to inhibit the rollers 18, 20, 22 and 24 from rotating and to hold the exhaust pipe lifting apparatus in place at a desired location for a lifting operation. Vertically extending support bars 28, 30, 32 and 34 extend upward from the base 16 to an upper horizontally extending support bar 36 and 38 forming a rectangular, box-shaped support frame 12.

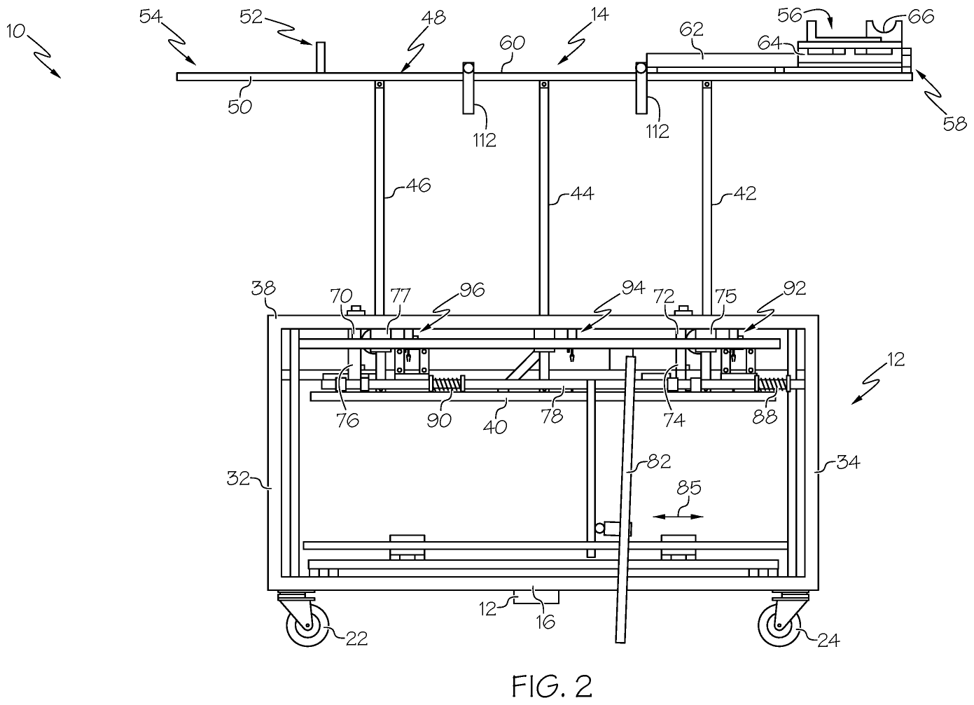

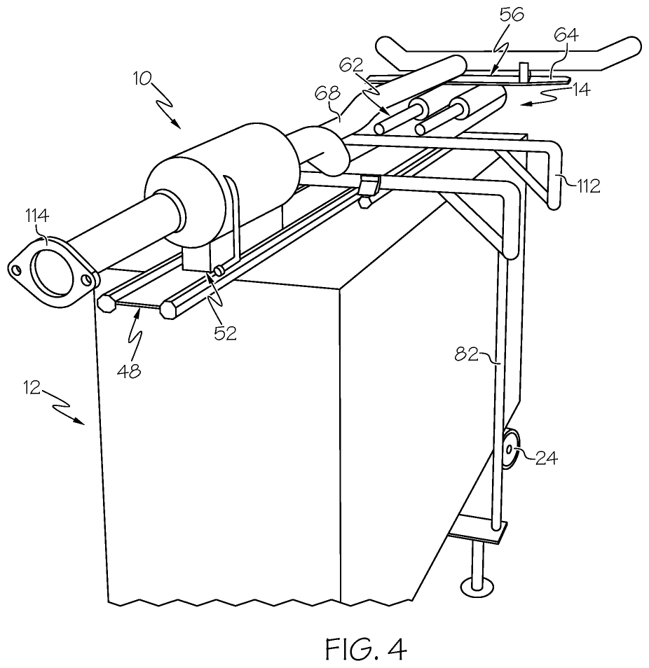

Referring also to FIG. 2, the exhaust pipe lifting apparatus 10 includes the lift table assembly 14. The lift table assembly 14 includes a lift bar 40 that extends horizontally between one or more vertically extending support struts 42, 44 and 46. The support struts 42, 44 and 46 extend vertically from the lift bar 40 to a lift table 48 forming a lift frame 50. The lift table 48 extends horizontally between the support struts 42, 44 and 46 and includes a first exhaust pipe support 52 at a first end 54 of the lift table 48 and a second exhaust pipe support 56 at an opposite second end 58 of the lift table 48. In the illustrated example, the first exhaust pipe support 52 may be stationary relative to horizontally extending table bars 59 and 60 and the second exhaust pipe support 56 may be slidable along the table bars 59 and 60 toward and away from the first exhaust pipe support 52. In particular, the second exhaust pipe support 56 may include a track 62 and a sliding carriage 64 that slides back and forth on the track 62. The carriage 64 includes a pipe support cradle 66 that is configured to hold a portion of an exhaust pipe 68 (FIG. 4). Sliding the carriage 64 can move the exhaust pipe 68 toward the first end 54 for an installation operation, as will be described in greater detail below.

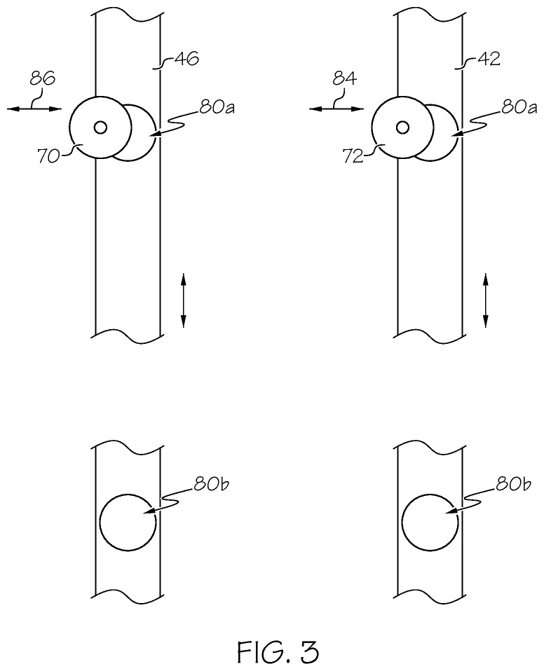

Referring still to FIGS. 1 and 2 and also to FIG. 3, the support frame 12 includes locking members in the form of rollers 70 and 72. The rollers 70 and 72 (e.g., wheels) are rotatably mounted to rods 74 and 76 that are, in turn, mounted to a sliding handle 78. Referring particularly to FIG. 3, the rollers 70 and 72 can roll along the support struts 42 and 46 while the support struts 42 and 46 slide up and down through linear bearings 75 and 77 (FIGS. 1 and 2) relative to the support frame 12. When the rollers 70 and 72 encounter locking features in the form of openings 80, the rollers 70 and 72 engage the support struts 42 and 46 within the openings 80 to lock a vertical position of the lift table assembly 14. In some embodiments, the support struts 42 and 46 may have upper openings 80a and lower openings 80b. The upper openings 80a can be used to lock the lift table assembly 14 in a lowered position and the lower openings 80b can be used to lock the lift table assembly 14 in a raised position. An actuation device that includes a lever 82 can be used to move the sliding handle 78 to a side represented by arrow 85 in order to move the rollers 70 and 72 out of the openings 80 and unlock the lift table assembly 14, as represented by arrows 84 and 86. In some embodiments, the sliding handle 78 may be biased toward an initial, unactuated position using springs 88 and 90. The lever 82 may extend from the sliding handle 78 toward the floor so that the lever 82 can be engaged and pushed to the side using a foot.

Referring again to FIGS. 1 and 2, one or more retracting devices, such as spring balancers 92, 94 and 96. The spring balancers 92, 94 and 96 may be actuation devices that are used to assist in raising and lowering the lift table assembly 14. The term “spring balancer” refers to a mechanical tool that is used to apply tension to a cable in order to retract the cable under a load. In some embodiments, the amount of tension applied to the cable by the spring balancer is related to the amount the cable is extended. For example, the more the cable is extended, the more tension is applied to the cable for the cable to retract. As can best be seen in FIG. 1, each spring balancer 92, 94 and 96 includes a cable 98, 100 and 102 and a housing 104, 106 and 108. The housings 104, 106 and 108 are fixedly mounted to the support frame 12 and the cables are connected to the lift bar 40. Because the spring balancers 92, 94 and 96 are constantly applying tension to the cables 98, 100 and 102, the weight of the overall lift table assembly 14 is reduced to the installer. The spring balancers 92, 94 and 96 can be used to gently raise and lower the lift table assembly 14 between the raised and lowered positions.

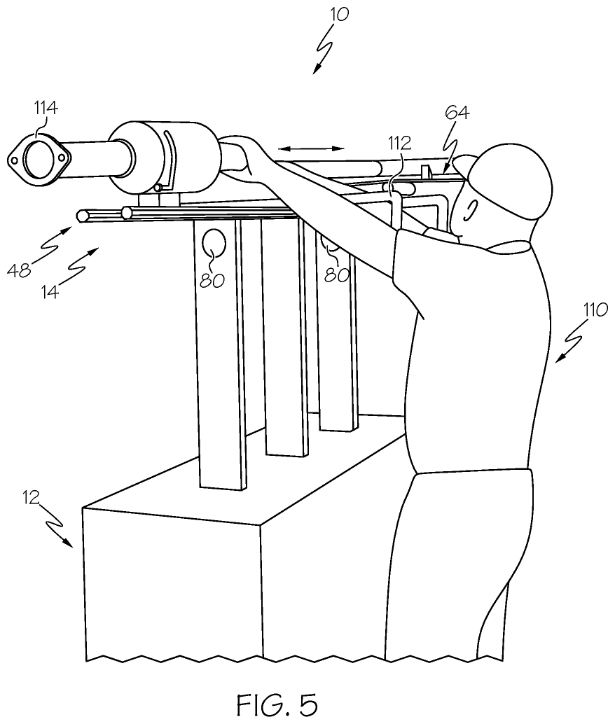

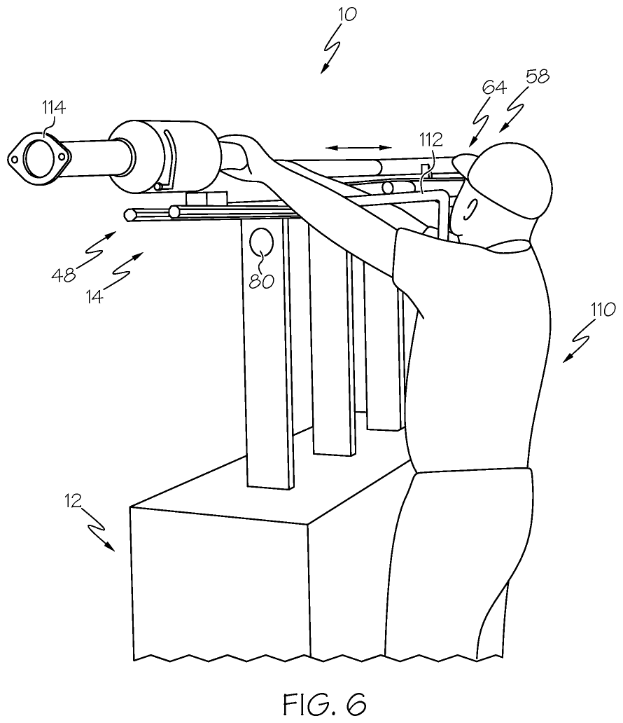

Referring to FIGS. 1-6, the installer 110 (FIGS. 4 and 5) can move the exhaust pipe lifting apparatus 10 and set the brake member 26 (FIG. 2). The installer 110 can grasp handles 112 using both hands once the exhaust pipe lifting apparatus 10 is in the desired location. The lever 82 can then be pushed to the side, which unlocks the rollers 70 and 72 from within the openings 80 with the lift table assembly 14 in the lowered position. The spring balancers 92, 94 and 96 are calibrated such that applying a gentle upward force on the lift table assembly 14 causes the lift table assembly 14 to lift with the exhaust pipe 68 located thereon to the raised position. Once in the lift table assembly 14 is in the raised position, the rollers 70 and 72 lock with the openings 80 to maintain the lift table assembly 14 in the raised position, illustrated by FIGS. 5 and 6. The installer 110 can then grasp the exhaust pipe 68 and slide the exhaust pipe toward end 54, moving the end 114 of the exhaust pipe 68 farther away from end 54 using the sliding second exhaust pipe support 56, track 62 and sliding carriage 64. Such sliding movement of the exhaust pipe 68 horizontally can place the exhaust pipe 68 in a better ergonomic position for installation. Once the exhaust pipe 68 is removed or installed, the lever 82 can again be pushed to the side and the lift table assembly 14 can be lowered to the lowered position.

The above-described exhaust pipe lifting apparatus can be used to lift exhaust pipes into position in a reliable fashion for an assembly process. The exhaust pipe lifting apparatus can use no pneumatics, electricity or hydraulics and can be entirely mechanically operated with less effort than without the exhaust pipe lifting apparatus. Further, the exhaust pipe lifting apparatus can be operated by a single person to install the exhaust pipe rather than multiple people. The exhaust pipe lifting apparatus can also improve the ergonomic conditions for installing the exhaust pipe due to the previous need of lifting the exhaust pipes manually.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An exhaust pipe lifting apparatus comprising:
a support frame;
a lift table assembly including a lift frame configured to move vertically relative to the support frame;
wherein the support frame includes a roller rotatably connected thereto that rolls against the lift frame as the lift frame moves between raised and lowered positions and interlocks with a locking feature on the lift frame in the raised position.

2. The exhaust pipe lifting apparatus of claim 1 further comprising a sliding handle operatively connected to the roller that is configured to move the roller between an engaged position interlocked with the locking feature and a disengaged position unlocked with the locking feature.

3. The exhaust pipe lifting apparatus of claim 2 further comprising an actuation device that is operatively connected to the sliding handle, the actuation device configured to be actuated to slide the sliding handle toward a side of the support frame to move the roller between the engaged position interlocked with the locking feature and the disengaged position unlocked with the locking feature.

4. The exhaust pipe lifting apparatus of claim 1, wherein the lift table assembly comprises:
a lift bar that extends horizontally;
a support strut that intersects the lift bar, the support strut extending vertically from the lift bar; and
a lift table that is configured to support an exhaust pipe thereon, the support strut intersecting the lift table such that the support strut extends between the lift bar and the lift table.

5. The exhaust pipe lifting apparatus of claim 4, wherein the support strut comprises the locking feature.

6. The exhaust pipe lifting apparatus of claim 5, wherein the locking feature comprises an opening through the support strut.

7. The exhaust pipe lifting apparatus of claim 6, wherein the roller is biased toward the support strut, such that the roller rolls along the support strut as the lift frame moves between raised and lowered positions.

8. The exhaust pipe lifting apparatus of claim 4, wherein the lift table comprises an exhaust pipe support that is configured to receive an exhaust pipe, the exhaust pipe support comprising a sliding carriage that is configured to slide along a length of the lift table assembly.

9. The exhaust pipe lifting apparatus of claim 8, wherein the exhaust pipe support is a second exhaust pipe support, the lift table assembly further comprising a first exhaust pipe support comprising a support cradle that is configured to receive the exhaust pipe, the second exhaust pipe support being slidable relative to the first exhaust pipe support.

10. The exhaust pipe lifting apparatus of claim 4 further comprising a retracting device mounted to the support frame, the retracting device comprising a cable that is connected to the lift bar, the retracting device configured apply a lift force to the lift table assembly.

11. A method of lifting an exhaust pipe using an exhaust pipe lifting apparatus, the method comprising:
placing an exhaust pipe on a lift table of a lift table assembly of the exhaust pipe lifting apparatus;
moving the exhaust pipe lifting apparatus to a desired position;
releasing a locking member mounted to a support frame of the exhaust pipe lifting apparatus from a locking feature carried by the lift table assembly;
applying a lifting force to the lift table assembly using a retracting device; and
lifting the lift table assembly relative to the support frame thereby lifting the exhaust pipe.

12. The method of claim 11, wherein the retracting device comprises a spring balancer comprising a housing that is mounted to the lift table assembly and a cable that is connected to a lift bar of the lift table assembly.

13. The method of claim 11 further comprising sliding the exhaust pipe horizontally along the lift table assembly using an exhaust pipe support carrying the exhaust pipe after the step of lifting the lift table assembly.

14. The method of claim 11 further comprising locking the exhaust pipe lifting apparatus in place using a brake member after the step of moving the exhaust pipe lifting apparatus.
